(19) United States
(12) Patent Application Publication
(10) Pub. No.: US 2023/0089423 A1
(43) Pub. Date: Mar. 23, 2023

(54) INLET FOR A HYDRODYNAMIC SCREW

(71) Applicant: TRANSMORO AB, Uppsala (SE)

(72) Inventor: Arne FJÄLLING, EKERÖ (SE)

(21) Appl. No.: 17/909,035

(22) PCT Filed: Mar. 5, 2021
(86) PCT No.: PCT/SE2021/050199

§ 371 Date: Sep. 2, 2022

(30) Foreign Application Priority Data
Mar. 5, 2020 (SE) 2050251-4
Jan. 12, 2021 (SE) 2150015-2

(51) Int. Cl. F03B 7/00; F03B 11/00

(52) U.S. Cl. CPC F03B 7/00; F03B 11/00; F05B 2240/243; F05B 2240/9176; F05B 2250/72; F05B 2260/04

(57) ABSTRACT

The present invention relates to an inlet for a hydrodynamic screw, the inlet comprising—a first end connectable to a hydrodynamic screw, the first end having a first opening—a second end for transporting water through the inlet towards the first end, the second end having a second opening, —an inlet body connecting the first end and the second end, the inlet body comprising a hollow that extends through the inlet body and connects the first opening and the second opening, wherein the inlet has a first diameter at the first opening and a second diameter at the second opening, the second diameter being larger than the first diameter, and wherein the nlet further comprises a ridge arranged on an inner surface of the hollow in a helix, the ridge having a height that increases towards the first end. The invention also relates to a hydrodynamic screw.

### TECHNICAL FIELD

The present invention relates to an inlet for a hydrodynamic screw for transporting water and organisms such as fish living in water. The inlet serves to guide water and organisms into the hydrodynamic screw in an efficient way to ascertain safe passage of organisms through the screw and also to decrease energy losses through turbulence. The inlet is suitable for hydrodynamic screws whose main purpose is the safe passage of organisms in water and at fish ladders, natural fish passages and in fish farming, but the inlet is also suitable for hydrodynamic screws of other types

### BACKGROUND

In waterways, natural passages exist that are insecure or outright dangerous to fish passing downstream. These are passages where fish are at risk of especially difficult or hazardous places such as hydroelectric power plants, artificial fish passages are often arranged. The efficacy of an artificial passage mainly depends on designing the passage and the flow of water in such a way that escape responses are not triggered, or at least not triggered before a point of no return has been reached from which the fish is unable to escape. The less dramatic but highly useful avoidance behavior of fish can also be used in order to render the passage more efficient.

Many passages comprise hydrodynamic screws such as Archimedes' screws in which water is transported through a rotation of the screw. Such screws are able to transport water upstream as well as downstream.

A problem within this field is that many passages are not designed in such a way that fish and other organisms living in water are able to pass unharmed. Also, another problem is that passages that are suited to allow fish to pass are instead inefficient as hydrodynamic screws for power generation since they are associated with energy losses that render power generation inefficient.

One prior art hydrodynamic screw with an inlet is known from DE102012012925A1 (Hübler), where an inlet that receives water that may contain fish from a feeding tube. However, this document does not disclose an inlet that is placed in a body of water so that fish can enter of their own volition but rather an inlet that receives a continuous supply of water that has reached the feeding tube through an undisclosed inlet. The inlet of the hydrodynamic screw itself comprises an outer edge to prevent water from escaping the inlet or to ensure that escaped water is not allowed to run along an outer surface of the hydrodynamic screw. This disclosure does not present an inlet that could be placed in a body of water and entice fish to enter and pass the hydrodynamic screw unharmed, in particular because the edge at the outer part of the inlet would act as a barrier to fish and would create turbulence in the water, leading to energy losses. There is also a ridge that extends along the inlet to the outer edge and that would further increase turbulence of the water and cause loss of energy in the turbine.

There is therefore a need for improvements that allow for safe and efficient passage of fish and other organisms living in water while at the same time being able to be used for other purposes such as power generation.

### SUMMARY

The object of the present invention is to eliminate or at least to minimize the problems discussed above. This is achieved by an inlet for a hydrodynamic screw according to the appended independent claims.

The inlet comprises a first end connectable to a hydrodynamic screw, the first end having a first opening, a second end for receiving water and organisms living in water for transporting through the inlet towards the first end, the second end having a second opening, and an inlet body connecting the first end and the second end, the inlet body comprising a hollow that extends through the inlet body and connects the first opening and the second opening. The inlet has a first diameter at the first opening and a second diameter at the second opening, the second diameter being larger than the first diameter. Furthermore, the inlet comprises a ridge arranged on an inner surface of the hollow, the ridge being arranged in a helix and the ridge further having a height that is larger in at least a first part than in at least a second part, said first part being closer to the first end than said second part.

Thereby, fish and other organisms living in water are urged or duly transported through the inlet in an efficient way so that they are unable to escape from the inlet once they have entered. Due to the ridge increasing in height fish are trapped as the inlet rotates by the ridge rising behind them so that they will follow the flow of water towards the first end that is configured to be attached to a hydrodynamic screw so that water and fish are guided into the screw.

It is also advantageous that the ridge may contribute to the filling of the hydrodynamic screw in embodiments where the ridge extends above an intended water level.

Suitably, the ridge has a maximum height at the first end, the maximum height being at least ¼ of the first diameter. Thereby, water is more efficiently transported to fill the inlet at the first end and contribute to an increased filling of the hydrodynamic screw. A larger flow through the hydrodynamic screw is thereby achieved.

Also, the inner surface of the hollow may form a funnel. Thereby, with the inlet having a smooth funnel shape, transport of water and fish is made convenient and efficient, and a water depth in the inlet will decrease gradually as a water speed increases.

Suitably, the ridge may be arranged in a helix with variable pitch so that at least one point on the ridge has a larger distance to the ridge in an axial direction towards the first end than a distance to the ridge in an axial direction towards the second end. Thereby, dimensions of the inlet may be adjusted so that compartments formed between one ridge portion and another ridge portion may vary in length and width while suitably maintaining a constant volume of compartments.

Also, the ridge may advantageously be arranged in a helix having a pitch in at least one portion of 10-40°, more preferably about 25° in relation to a normal to an axial direction. This is advantageous in allowing the ridge to move in the axial direction as the inlet rotates with a speed that is close to the speed of water in the inlet, so that energy losses due to turbulence are decreased.

Also, the ridge in at least one part may suitably extend from the surface of the inlet body to an intended water level, said intended water level being a plane that intersects the inlet at the first end and at the second end and that extends essentially horizontally when the inlet is in use in a body of water.

Thereby, an increased degree of filling of the hydrodynamic screw may be achieved, since the ridge extending to the water level or above will trap water to allow for a larger flow into the hydrodynamic screw so that capacity of the hydrodynamic screw is suitably maximized. Another advantage is that the flow of water into the hydrodynamic screw can be kept constant or near constant despite variations in the water depth in the inlet. This is especially beneficial in situations where the water level upstream of the inlet varies since the flow of water into the hydrodynamic screw and the degree of filling of the screw may be kept at a desired level without requiring adjusting the position or orientation of the inlet.

Suitably, the ridge has a starting point that is flush with the inner surface of the inlet body, and wherein the ridge extends from the starting point towards the first end. Thereby, the ridge starts from a level of the inner surface so that a transition from the inner surface to an upper side of the ridge is smooth. Injury to the fish entering the inlet is thereby prevented. It is also beneficial in decreasing turbulence of the water.

Also, the starting point of the ridge is suitably at a distance from the second end. Thereby, there is a portion of the inlet at the second end that lacks the ridge so that fish entering the inlet is presented with a smooth inner surface. This is beneficial in preventing damage to the fish and it is also an advantage in decreasing turbulence of the water.

Furthermore, the inner surface is suitably substantially planar at the second end. This is beneficial in preventing damage to fish as it enters the inlet and also serves to decrease turbulence.

The invention also comprises a hydrodynamic screw having an inlet according to the invention.

Many additional benefits and advantages of the present invention will be readily understood by the skilled person in view of the detailed description below.

### DRAWINGS

The invention will now be described in more detail with reference to the appended drawings, wherein

FIG. 1 discloses a cross-sectional view from the side of an inlet according to a first embodiment of the present invention;

FIG. 2a discloses a cross-sectional view from the side of an inlet according to a second embodiment;

FIG. 2b discloses cross-sectional areas for each zone in FIG. 2b;

FIG. 3 discloses a cross-sectional view from the side of an inlet according to a third embodiment;

FIG. 4 discloses a cross-sectional view from the side of an embodiment in which the hydrodynamic screw is adapted to allow more water to enter into the screw; and

FIG. 5 discloses a perspective view from the second end of the inlet according to the invention.

### DETAILED DESCRIPTION

The inlet according to the present invention and the hydrodynamic screw on which it is mounted or with which it is integrally formed are intended for transporting water and organisms living in water. In the following, such organisms are referred to as fish but it is to be noted that other organisms may also be transported by means of the invention. Thus, when the term “fish” is used in the following, this should be construed as including any other organisms that live in water.

The inlet is suitable for hydrodynamic screws whose main purpose is the safe passage of organisms in water and at fish ladders, natural fish passages and in fish farming, but the inlet is also suitable for hydrodynamic screws of other types.

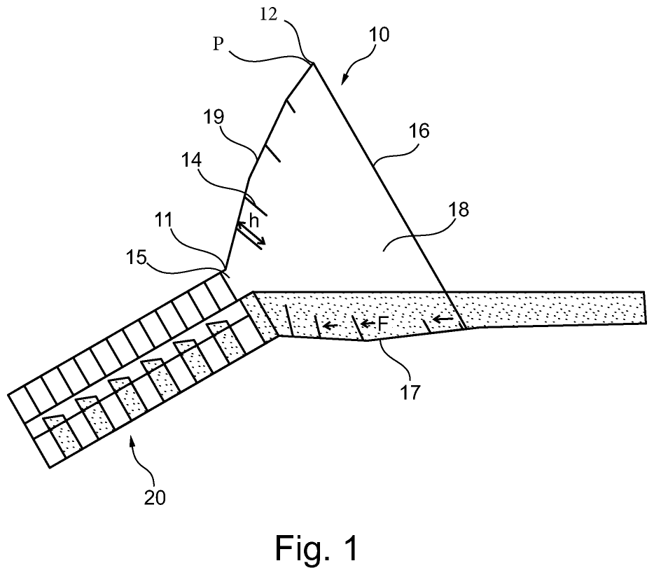

FIG. 1 discloses a first embodiment of an inlet 10 suitable for mounting on or integrally formed with a hydrodynamic screw 20, according to the present invention. The inlet 10 is intended for placing in water as shown schematically in the figure, with a flow direction F of the water indicated. The hydrodynamic screw 20 may be an Archimedes' type screw or any other kind of screw that is intended to rotate and thereby transport a quantity of water downstream.

The inlet 10 comprises an inlet body 17 with a first end 11 that is connectable to the hydrodynamic screw 20 and has a first opening 15 through which water can flow in order to reach the hydrodynamic screw 20. The inlet 10 also comprises a second end 12 with a second opening 16. The inlet body 17 comprises a hollow 18 so that water that enters the second opening 16 can be transported to the first opening 15 and therethrough into the hydrodynamic screw 20. In some embodiments, the inlet 10 may be fixed to the hydrodynamic screw 20 so that they are able to rotate together, but in other embodiments the inlet 10 may be mounted on the hydrodynamic screw 20 but still be rotatable in relation to the hydrodynamic screw 20 so that they may rotate at different speeds.

The inlet body 17 further comprises an inner surface 19 on which a ridge 14 is arranged in the form of a helix. The ridge 14 may extend perpendicularly from the inner surface 19 or may extend at another angle, and the ridge 14 may be curved or straight in a direction away from the inner surface 19. The ridge 14 further has a height h from the inner surface 19, said height h increasing in a direction towards the first end 11 so that the ridge 14 har a larger height h closer to the first end 11 than a height of the ridge 14 closer to the second end 12. Furthermore, the increasing height h may increase in one portion of the ridge 14 or may alternatively increase along an entire length of the ridge 14 from a start at or near the second end 12 to an end at or near the first end 11. The ridge 14 may also be arranged on a part of the inner surface 19 or may alternatively extend all the way from the second end 12 to the first end 11. In one embodiment, the ridge 14 may also be divided into at least two ridges that each extend along a part of the inner surface 19 or that run in parallel along at least one part of the inner surface 19.

Suitable dimensions for an inlet 10 according to the present invention is that the first diameter is in the range of 3-6 m and the second diameter is about two times the first diameter. A length of the inlet body from the first end 11 to the second end 12 is suitably about 1.5 times the first diameter, and a length of the inlet body in a direction from the first end 11 to the second end 12 from a point where the ridge 14 starts to a point where the ridge 14 ends is suitably about 1.2 times the first diameter. Depending on the pitch of the helix shaped ridge 14, a length of the ridge 14 itself varies.

Preferably, the ridge 14 has a pitch of 10-40°, more preferably about 25° in relation to a normal to an axial direction of the inlet body 17. The pitch of the ridge 14 may vary along the ridge 14 from the second end 12 to the first end 11 and it is suitable that the variations are kept within the range of 20-40° since it allows for the ridge to move in the axial direction as the inlet body 17 rotates with a speed that is close to a speed of the water. Said water speed is determined by shape and inclination of the inlet body 17 and suitably the water speed increases from about 0.1-0.2 m/s at the second end to 0.5-1 m/s at the first end. By gradually increasing the water speed fish are encouraged to enter the inlet body 17 and the higher speed towards the second end as well as the presence of the ridge 14 efficiently prevent the fish from escaping once they have entered the inlet body 17. In one embodiment, the ridge 14 may also have a variable inclination in relation to the inlet body 17.

In one embodiment, the ridge 14 has a height h that is equal to or more than an intended depth of water at the first end 11 and proceeds with an equal height or varying only marginally to a point about half-way between the first end 11 and the second end 12. From that point onwards, the ridge 14 tapers to zero in a vicinity of the second end 12. An intended depth of water in the inlet 10 would in that embodiment be about ⅕ of the first diameter at the second end 12 and increasing to about ⅓ of the first diameter at the second end 12 to ensure an efficient filling of the hydrodynamic screw 20. Along the inlet body 17, compartments are formed between two neighboring revolutions of the helix shaped ridge 14, and a suitable volume for one such compartment may be about 8 m³ for an inlet 10 connected to a hydrodynamic screw 20 that is dimensioned for a flow of 3 m³/s.

As also shown in FIG. 1, the inlet body 17 may have a diameter that increases gradually in an axial direction from the first end 11 to the second end 12 but may in other embodiments have a diameter that is constant along at least one part of the inlet body 17 or that may increase discontinuously or even decrease in at least a part of the inlet body 17 in the axial direction from the first end 11 to the second end 12.

The inlet body 17 may be rotationally symmetrical around a central axis A but may in some embodiments alternatively have a shape that is not symmetrical.

Also shown in FIG. 1 is a starting point P on the inner surface 19 where the ridge 14 starts. In the starting point P, the ridge 14 is flush with the inner surface 19 so that the ridge 14 only gradually rises from the inner surface 19 and proceeds in the helix shape towards the first end 11. That the starting point P is flush with the inner surface 19 is to be understood as the starting point P being a point on the inner surface 19 from which the ridge 14 extends, so that the starting point P does not protrude from the inner surface 19.

This is advantageous in preventing damage to fish due to a sudden start of the ridge 14 that would otherwise occur if the ridge 14 had a height that extended above the inner surface 19 in the starting point P. Turbulence is also decreased which is a further benefit.

Furthermore, it is advantageous if the starting point P is at a distance from the second end 12 so that a part of the inlet body 17 between the starting point P and the second end 12 in the axial direction lacks the ridge 14. This creates a smooth segment of the inner surface 19 that allows fish to enter into the inlet body 17 without risking damage due to interaction with the ridge 14.

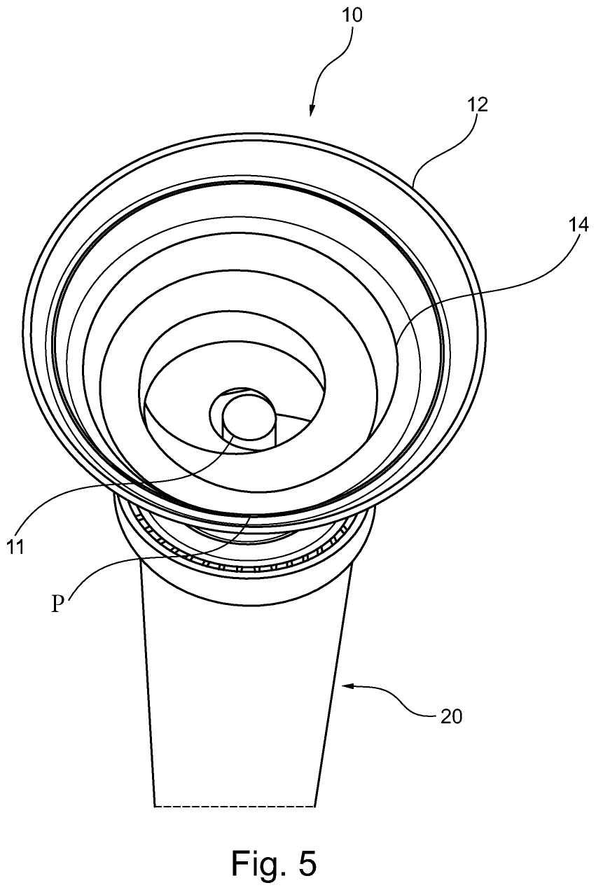

The starting point P is also shown in FIG. 5 where it can be seen that a part of the inlet body 17 close to the second end 12 lacks the ridge 14.

It is also an advantage if the inner surface 19 is substantially planar at the second end 12 so that edges or raised portions that extend from the inner surface 19 are avoided. This serves to decrease turbulence and also to allow fish to enter into the inlet body 17 without risking damage due to interaction with such an edge or raised portion. When the term “substantially planar” is used herein, this is to be understood as the inner surface 19 forming a plane or a series of connected planes that together form a surface in which no part has an inclination of more than 30°, preferably no more than 20° and more preferably no more than 10°. Since the second end 12 of the inlet body 17 is circular in shape, it follows that the inner surface 19 being substantially planar allows for the surface to be curved slightly, but since a suitable diameter of the inlet body at the second end 12 is in the range of 6-12 m, the inner surface 19 will be curved with such a large radius that it will be substantially planar in any given point. It is important, however, to avoid protrusions on the inner surface 19 at the second end 12 so that damage to the fish may be avoided and turbulence of the water flowing into the inlet kept low.

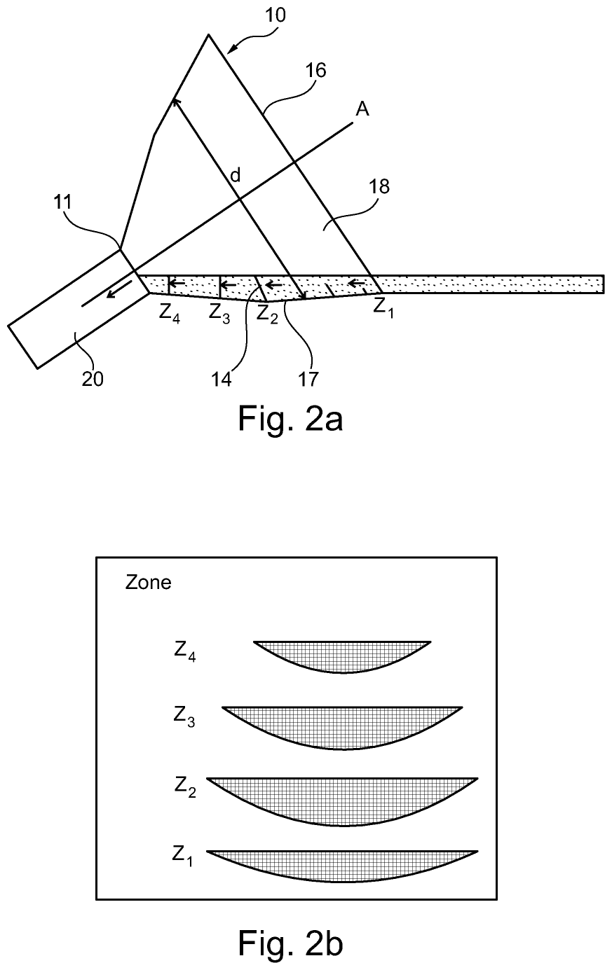

FIG. 2a discloses a second embodiment where a diameter d varies so that different zones are created for allowing fish to travel unhindered through the inlet 10. Each zone may be a compartment formed between two neighboring revolutions of the ridge 14, but optionally a zone could instead include more than one revolution of the ridge 14, especially in embodiments where the height of the ridge 14 does not extend up to or above an intended water level. In a first zone Z1 is the second end 12 with an entrance into the inlet 10. In a flow direction F or a direction from the second end 12 towards the first end 11 along the inlet body 17, a calm zone follows until a trap point is reached in a second zone Z2. The trap point is a point at which fish are trapped and no longer able to escape from the inlet 10. This may be because a velocity of the water is higher than a maximum swimming velocity of the fish or may alternatively be because the ridge 14 extends from the inlet body 17 to or above a height where a water surface is intended to be, so that the ridge 14 completely blocks the fish from swimming back towards the second end 12. A third zone Z3 with a decreasing diameter d follows in the flow direction F and a fourth zone Z4 is at the first end 11 and is the last zone to be reached by water or fish that enter the second end 12.

FIG. 2b also discloses a cross-sectional area of a part of the inlet 10 that is intended to be under water when the inlet 10 is in use. Such intended area under water is shown for each of the zones Z1, Z2, Z3 and Z4 along with their relative surface area and relative velocity of water due to the shape of the inlet 10. For the zones depicted in FIG. 2b and for an inlet with a maximum diameter of 10 m, the cross-sectional area shown is 1.8 m² (Z1), 3.5 m² (Z2), 2.3 m² (Z3), and 1.6 m² (Z4), respectively. The water velocity in each of the zones is in this embodiment 0.5 m/s (Z1), 0.2 m/s (Z2), 0.3 m/s (Z3), and 0.5 m/s (Z4), respectively. These cross-sectional areas and water velocities are given as an example for the embodiment of FIG. 2a and may be seen as showing suitable dimensions for creating the zones described herein.

As can be seen, the area under water increases from the first zone Z1 to the second zone Z2 and decreases gradually in the third zone Z3 and the fourth zone Z4. The purpose of this is to create a calmer area between the first zone Z1 and the second zone Z2 in which the fish is calmed so that it does not attempt to escape until the trap point has been reached. As stated above, the trap point can be a point where the ridge 14 rises to cover the entire area under water so that no water and hence no fish can escape in a direction towards the first end 12, but it may alternatively be a point where the velocity of the water has increased to a point where fish are unable to swim upstream. That velocity is for most species of fish in a range of 0.5-1.5 m/s but may also be lower for some.

It is advantageous to vary a wetted transect surface area of each zone or compartment, since this serves to vary the water velocity in the different zones or compartments. Factors that determine the volume apart from the water level in the inlet 10 are the shape of the inlet body 17 and the pitch of the ridge 14.

A zone may be defined as a portion of the inlet body that lies between a first ridge portion and a second ridge portion, wherein the ridge portions are selected so that one point on the first ridge portion has one point on the second ridge portion as a neighbor in the axial direction. In other words, the first ridge portion and the second ridge portion are adjacent to each other in the axial direction. The zone is then formed in a portion of the inlet body between the first ridge portion and the second ridge portion that is covered with water. This means that a zone volume, defined as a water volume held in the zone, is delimited by the first ridge portion, the second ridge portion, the inner surface of the inlet body 17 and an intended water level. During passage through the inlet, water is supplied to the second end 12 and flows through the inlet towards the first end 11 and onwards into the hydrodynamic screw 20.

The intended water level is defined herein as a plane that intersects the inlet 10 at the first end 11 and at the second end 12 and that extends essentially horizontally when the inlet 10 is placed in water. In order to function efficiently, the intended water level should intersect the first end 11 at or below a middle of the first diameter, but in practice an efficient filling of the hydrodynamic screw may be achieved when the intended water level is at a height from a lower end of the first end 11 that is about ⅓ of the first diameter. Suitably, the intended water level should be above ⅕ of the first diameter to ensure a satisfactory filling of the hydrodynamic screw.

Advantageously, the inlet 10 comprises at least two zones that are configured so that a zone length of one zone may differ from a zone length of the other zone while the zone volume is constant. This ensures that the water velocity in the zones differ, so that one of the zones may function as a calmer zone that is not perceived as threatening to the fish, whereas the other zone ensures a quicker transport of fish towards the hydrodynamic screw 20 after the trap point has been reached, either through an increase in the water velocity of through the ridge 14 extending up to the water level so that the fish is unable to escape.

The flow of water (volume per unit of time) in the inlet of FIG. 2a is the same in each of the zones Z1, Z2, Z3, Z4 of FIG. 2a-2b but the water speed differs due to the difference in cross-sectional area for each of the zones as shown above. This achieves the effect of calmer zones or zones with a water speed above the swim speed of fish so that the trap point is reached.

The increasing height of the ridge 14 is advantageous in allowing for a gradual trapping of fish to ensure that fish are guided towards the first end 11 but also that the ridge 14 itself does not cause damage to the fish.

In some embodiments, the ridge 14 forms a helix with variable pitch so that the distance from one point on the ridge 14 to another point on the ridge 14 in an axial direction, i.e. after a full revolution, differs. In this way compartments are created with varying axial dimensions. In some embodiments, the zones Z1, Z2, Z3, Z4 may be created by varying the pitch of the helix formed by the ridge 14 so that the cross-sectional areas of each zone fulfil the desired criteria of achieving a calm zone or a zone that has a water speed above the trap point for the fish. In other embodiments, the zones Z1, Z2, Z3, Z4 may instead be achieved only by adjusting the shape of the inlet body 17 while keeping the helix formed by the ridge 14 in a constant pitch, and in yet another embodiment the shape of the inlet body 17 and the pitch of the ridge 14 may be adjusted so that the desired zones are achieved.

In the Figures, the inlet 10 according to the present invention is shown with four zones, but it is to be noted that fewer or more zones could equally be used. It is advantageous to have at least one calmer zone and at least one with a higher water speed, wherein the calmer zone is closer to the second end 12 than the zone with the higher water speed. In this way, the entering of fish into the inlet body 17 is facilitated since the fish are more inclined to enter the inlet 10 if the water speed is lower. At the same time, the zone of higher water speed facilitates the transport of the fish through the first end 11 and into the hydrodynamic screw 20.For the embodiments shown in FIG. 1 and FIG. 2, the height of the ridge 14 may be at least ½ to ⅔ of the height to the water level to ensure that the fish are trapped, but for some species of fish the ridge 14 may need to extend all the way to the water level in order to achieve this. Close to the first end 11, the ridge 14 may be constant at its maximum height for at least one revolution in order to efficiently trap the fish and prevent them from escaping towards the second end 12.

For some embodiments, the ridge 14 may start at or very close to the second end 12, but in other embodiments the start of the ridge 14 may instead be at a distance from the second end 12. In such embodiment a visual line in the form of a helix may be painted from the start of the ridge 14 and onwards towards the second end 12 to provide a visual cue to the fish in order to further facilitate their way into the inlet 10. The visual line is seen by the fish as a point of reference that moves forward (due to the rotation of the inlet 10) and this gives the impression that the inlet 10 is wide and does not risk capturing or trapping the fish. For this reason stress and fear are minimized and the progress of the fish further into the inlet 10 is facilitated. As the fish proceed further towards the first end 11, the ridge 14 rises and closes the way back towards the second end 12. For most species of fish it would be sufficient for the ridge 14 to reach ½ to ⅔ of a distance to a water surface, since this will be perceived by the fish as sufficient hinderance to prevent a turning back.

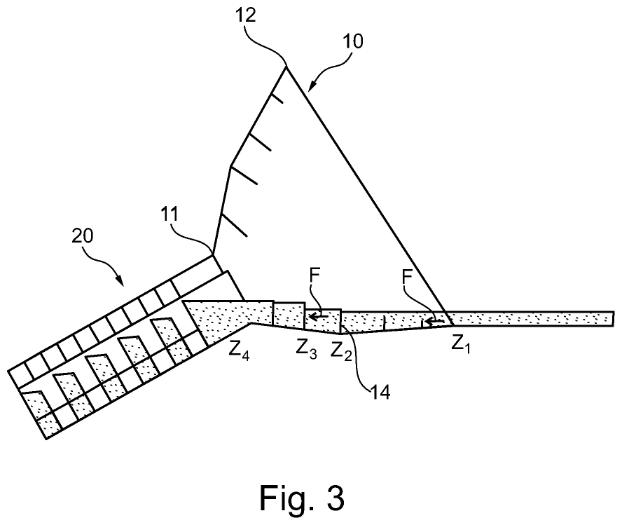

FIG. 3 discloses a third embodiment of the present invention that differs from the first and second embodiment in that the ridge 14 has an increasing height that not only achieves the benefits described above but also an increase in a water depth at the first end 11 so that the hydrodynamic screw 20 can be filled to a greater degree. This is advantageous in compensating for fluctuations in water depth in the inlet 10 that may arise when the water depth varies in a stream, lake, dam or other waterway where the inlet 10 is placed. By the ridge 14 increasing in height, the depth in the inlet 10 can be increased gradually in a direction towards the first end 10 and aids in achieving an efficient filling of the hydrodynamic screw 20.

A distance across the inlet body 17 in a radial direction is in the above referred to as a diameter d. This is not to be taken as implying that the inlet body 17 has a circular cross-section in a radial direction, but instead a diameter is only to be interpreted as a distance in a radial direction, wherein a radial direction is a direction that is perpendicular to an axial direction from the first end 11 to the second end 12.

The shape of the inlet body 17 of the inlet 10 may further be adapted to control the flow of water.

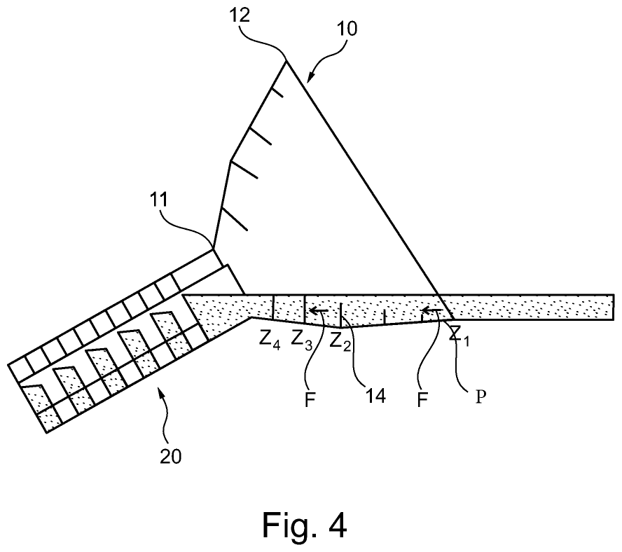

FIG. 4 discloses an embodiment that is similar to that of FIG. 1 and FIG. 2, but where the ridge 14 increases in height in a way similar to the embodiment of FIG. 3 so that an improved filling of the hydrodynamic screw 20 is achieved. Due to the ridge 14 extending up to and above the intended water level, compartments are formed that lift the water to a desired level before entering the hydrodynamic screw 20. This is especially advantageous in compensating for fluctuating water levels in the inlet 10, so that an efficient filling of the hydrodynamic screw 20 is possible even when the water level in the body of water where the inlet 10 is placed varies. A lower than desired water level would otherwise lead to a lowered efficiency, whereas a higher than desired water level would instead result in an overflow in the hydrodynamic screw that would cause leakage inside the screw and also decrease efficiency. In most prior art solutions, the hydrodynamic screw and its inlet need to be adjusted in height or inclination to compensate for such fluctuations, rendering this solution with the ridge 14 of increasing height highly beneficial. Another benefit of the ridge 14 extending up to and above the intended water level is that the flow of water into the hydrodynamic screw is constant or near constant due to the ridge forming compartments of known volume. Near constant is defined herein as being a variation of less than 10%, suitably less than 5% of a value. Constant is defined as being a variation of less than 4%, suitably less than 2% and more suitably less than 1% of a value.

When lifting the water in this way, the height of the ridge 14 and the shape of the inlet body 17 near the first end 11 are designed in such a way that compartments of equal or near to equal volume are created and that the water velocity is the same or nearly the same as the water velocity would have been if the ridge 14 had been lower so that such compartments are not formed. In this way, a given volume of water is gradually lifted towards the first end and leakage back towards the second end 12 is prevented while at the same time minimizing turbulence.

FIG. 5 discloses the inlet 10 of the present invention seen from the second end 12, so that the ridge 14 is clearly visible. The compartments or zones that may be formed in the inlet 10 when it is placed is formed between consecutive revolutions of the ridge 14.

It is to be noted that features from the various embodiments described herein may freely be combined, unless it is explicitly stated that such a combination would be unsuitable.

1. Inlet for a hydrodynamic screw for transporting water and organisms such as fish living in water, the inlet (10) comprising
a first end (11) connectable to a hydrodynamic screw, the first end having a first opening,
a second end (12) for receiving water and organisms living in water for transporting through the inlet towards the first end, the second end having a second opening, and
an inlet body (17) connecting the first end (11) and the second end (12), the inlet body (17) comprising a hollow that extends through the inlet body (17) and connects the first opening and the second opening, wherein
the inlet (10) has a first diameter at the first opening and a second diameter at the second opening, the second diameter being larger than the first diameter, and
the inlet (10) further comprises a ridge (14) arranged on an inner surface (19) of the hollow, the ridge (14) being arranged in a helix and the ridge (14) further having a height (h) that is larger in at least a first part than in at least a second part, said first part being closer to the first end than said second part.

2. Inlet according to claim 1, wherein the height (h) of the ridge (14) has a maximum height at the first end, the maximum height being at least ¼ of the first diameter.

3. Inlet according to claim 1, wherein the inner surface (19) of the hollow forms a funnel.

4. Inlet according to claim 1, wherein the ridge (14) is arranged in a helix with variable pitch so that at least one point on the ridge has a larger distance to the ridge in an axial direction towards the first end (11) than a distance to the ridge in an axial direction towards the second end (12).

5. Inlet according to claim 1, wherein the ridge (14) is arranged in a helix having a pitch in at least one portion of 10-40°, more preferably about 25°.

6. Inlet according to claim 1, wherein the ridge (14) in at least one part extends from the inner surface (19) of the inlet body to an intended water level, said intended water level being a plane that intersects the inlet (10) at the first end (11) and at the second end (12) and that extends essentially horizontally when the inlet (10) is in use in a body of water.

7. Inlet according to claim 1, wherein the ridge (14) has a starting point (P) that is flush with the inner surface (19) of the inlet body (17), and the ridge (14) extends from the starting point (P) towards the first end (11).

8. Inlet according to claim 7, wherein the starting point (P) of the ridge (14) is at a distance from the second end (12).

9. Inlet according to claim 8, wherein the inner surface (19) comprises a visual line that extends in a helix from the starting point (P) towards the second end (12).

10. Inlet according to claim 1, wherein the inner surface (19) is substantially planar at the second end (12).

11. Hydrodynamic screw comprising an inlet according to claim 1.

12. Inlet according to claim 3, wherein the inner surface (19) of the hollow forms a funnel.

13. Inlet according to claim 12, wherein the ridge (14) is arranged in a helix with variable pitch so that at least one point on the ridge has a larger distance to the ridge in an axial direction towards the first end (11) than a distance to the ridge in an axial direction towards the second end (12).

14. Inlet according to claim 3, wherein the ridge (14) is arranged in a helix with variable pitch so that at least one point on the ridge has a larger distance to the ridge in an axial direction towards the first end (11) than a distance to the ridge in an axial direction towards the second end (12).

15. Inlet according to claim 2, wherein the ridge (14) is arranged in a helix with variable pitch so that at least one point on the ridge has a larger distance to the ridge in an axial direction towards the first end (11) than a distance to the ridge in an axial direction towards the second end (12).

16. Inlet according to claim 15, wherein the ridge (14) is arranged in a helix having a pitch in at least one portion of 10-40°, more preferably about 25°.

17. Inlet according to claim 14, wherein the ridge (14) is arranged in a helix having a pitch in at least one portion of 10-40°, more preferably about 25°.

18. Inlet according to claim 13, wherein the ridge (14) is arranged in a helix having a pitch in at least one portion of 10-40°, more preferably about 25°.

19. Inlet according to claim 12, wherein the ridge (14) is arranged in a helix having a pitch in at least one portion of 10-40°, more preferably about 25°.

20. Inlet according to claim 4, wherein the ridge (14) is arranged in a helix having a pitch in at least one portion of 10-40°, more preferably about 25°.
